(19) United States
(12) Patent Application Publication
(10) Pub. No.: US 2024/0240531 A1
(43) Pub. Date: Jul. 18, 2024

(54) WEAR RESISTANT TUBULAR MEMBERS AND METHODS AND DEVICES FOR PRODUCING THE SAME

(71) Applicant: National Oilwell Varco, L.P., Houston, TX (US)

(72) Inventors: Richard Griffin, Cypress, TX (US); Lucien Hehn, Spring, TX (US); Cameron Spiller, Torrance, CA (US)

(73) Assignee: National Oilwell Varco, L.P., Houston, TX (US)

(21) Appl. No.: 18/563,296

(22) PCT Filed: May 20, 2022
(86) PCT No.: PCT/US2022/030250

§ 371 Date: Nov. 21, 2023

Related U.S. Application Data
(60) Provisional application No. 63/192,676, filed on May 25, 2021.

(51) Int. Cl. E21B 17/10

(52) U.S. Cl. CPC E21B 17/1085

(57) ABSTRACT

A tubular member includes a central axis, a first end, a second end opposite the first end, and an outer surface extending from the first end to the second end. In addition, the tubular member includes a weld overlay disposed on a portion of the outer surface that is axially spaced from the first end and the second end, wherein the weld overlay comprises a plurality of weld beads.

### CROSS-REFERENCE TO RELATED APPLICATIONS

This application claims benefit of U.S. provisional patent application Ser. No. 63/192,676 filed May 25, 2021, and entitled “Wear Resistant Tubular Members and Methods and Devices For Producing The Same,” which is hereby incorporated herein by reference in its entirety.

### STATEMENT REGARDING FEDERALLY SPONSORED RESEARCH OR DEVELOPMENT

Not applicable.

### BACKGROUND

Elongate tubulars are used in many industrial applications, such as, for example, oil and gas drilling, production, transportation, refining, etc. In oil and gas drilling operations, a drill bit is threadably attached at one end of a tubular and the tubular is rotated (e.g., from the surface, downhole by a mud motor, etc.) in order to form a borehole. As the bit advances within the formation, additional tubulars are attached (e.g., threadably attached) at the surface, thereby forming a drill string which extends the length of the borehole. In addition, elongate strings of tubulars may be utilized to form a casing or liner pipes within the borehole, as well as tubing for conveying fluids into and/or out of the borehole (e.g., formation fluids, injection fluids, etc.).

### BRIEF SUMMARY OF THE DISCLOSURE

Some embodiments disclosed herein are directed to a tubular member. In some embodiments, the tubular member includes a central axis, a first end, a second end opposite the first end, and an outer surface extending from the first end to the second end. In addition, the tubular member includes a weld overlay disposed on a portion of the outer surface that is axially spaced from the first end and the second end, wherein the weld overlay comprises a plurality of weld beads.

Some embodiments disclosed herein are directed to a method of manufacturing a tubular member. The tubular member comprises a central axis, a first end, a second end opposite the first end, and an outer surface extending from the first end to the second end. In some embodiments, the method includes (a) energizing a welding electrode that is positioned adjacent to the outer surface. In addition, the method includes (b) moving at least one of the tubular member or the welding electrode during (a). Further, the method includes (c) forming a weld overlay comprising a plurality of weld beads on a portion of the outer surface that is axially spaced from the first end and the second end with the welding electrode during (a) and (b).

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic view of a drilling system including a tubular member according to some embodiments;

FIG. 2 is a partial cross-sectional view of a tubular member for use within the drilling system of FIG. 1 according to some embodiments;

FIG. 3 is a schematic view of a system which may be used to manufacture the tubular member of FIG. 2 according to some embodiments;

FIG. 4 is a flowchart illustrating a method for manufacturing a tubular member according to some embodiments;

FIGS. 5 and 6 are schematic views of systems that may be used to manufacture the tubular member of FIG. 2 according to some embodiments; and

FIG. 7 is a flowchart illustrating a method of manufacturing a tubular member according to some embodiments.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to.” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the words “about,” “generally,” “substantially,” “approximately,” and the like, when used in reference to a stated value, mean within a range of plus or minus 10% of the stated value. Any reference to up or down in the description and the claims is made for purposes of clarity, with “up”, “upper”, “upwardly”, “uphole”, or “upstream” meaning toward the surface of the wellbore or borehole and with “down”, “lower”, “downwardly”, “downhole”, or “downstream” meaning toward the terminal end of the wellbore or borehole, regardless of the wellbore or borehole orientation.

In addition, as used herein, the term “threads” broadly refer to a single helical thread path, to multiple parallel helical thread paths, or to portions of one or more thread paths, such as multiple roots axially spaced-apart by crests.

As previously described above, during a borehole drilling operation, an earth-boring drill bit is mounted on the lower end of a drill string and is rotated by rotating the drill string at the surface, by actuation of downhole motors or turbines, or both. With weight applied to the drill string, the rotating drill bit engages the earthen formation and proceeds to form a borehole along a predetermined path toward a target zone. During drilling, the drill string may engage the sidewall of the borehole and may result friction therebetween and in wear along the outer surface of the drill string. Such engagement may be particularly pronounced in horizontal drilling operations where the path of the borehole departs from vertical. The wear along the outer surface of the drill string may reduce the strength and service life of the tubular members.

Accordingly, embodiments disclosed herein include tubular members and methods for producing tubular members, which may have a greater service life and durability than standard tubular members. In particular, the disclosed systems and methods may provide tubular members for drill strings which have increased fatigue resistance, wear resistance, and or damage tolerance. In some embodiments, a tubular member may include a pattern of welds (e.g., helical patterns) along a region of the tubular member that may engage with the borehole during a drilling operation.

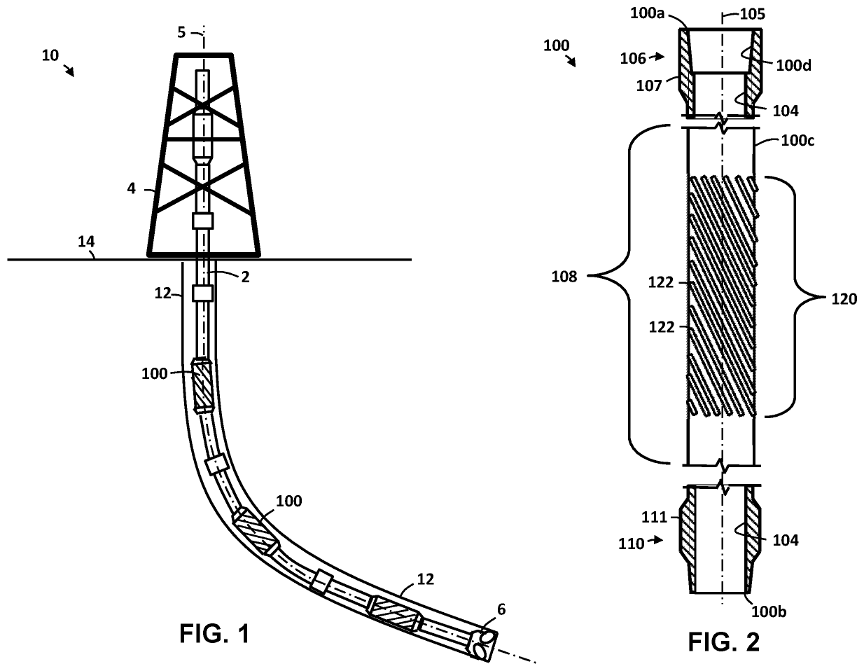

FIG. 1 is a schematic diagram of an embodiment of a well system 10 for forming a borehole 12 in a subterranean formation according to some embodiments. Well system 10 generally includes a derrick 4 disposed at the surface 14, a drill string 2 extending along an axis 5 from the derrick 4 into borehole 12, and a drill bit 6 coupled to a downhole end of the drill string 2. Drill string 2 comprises one or more tubular members 100, which may also be referred to herein as a pipe joints, coupled together in an end-to-end fashion to form drill string 2. With weight applied to drill string 2 and or drill bit 6, drill bit 6 may be rotated (e.g., with a top drive disposed at the surface, a mud motor disposed within borehole 12, etc.) to form borehole 12. Borehole 12 may be oriented generally vertical (e.g., aligned with the direction of gravity), horizontal (e.g., extending perpendicularly to the direction of gravity), and/or at some angle therebetween. Although FIG. 1 shows a land-based drilling system, the present disclosure is also applicable to off-shore well drilling systems.

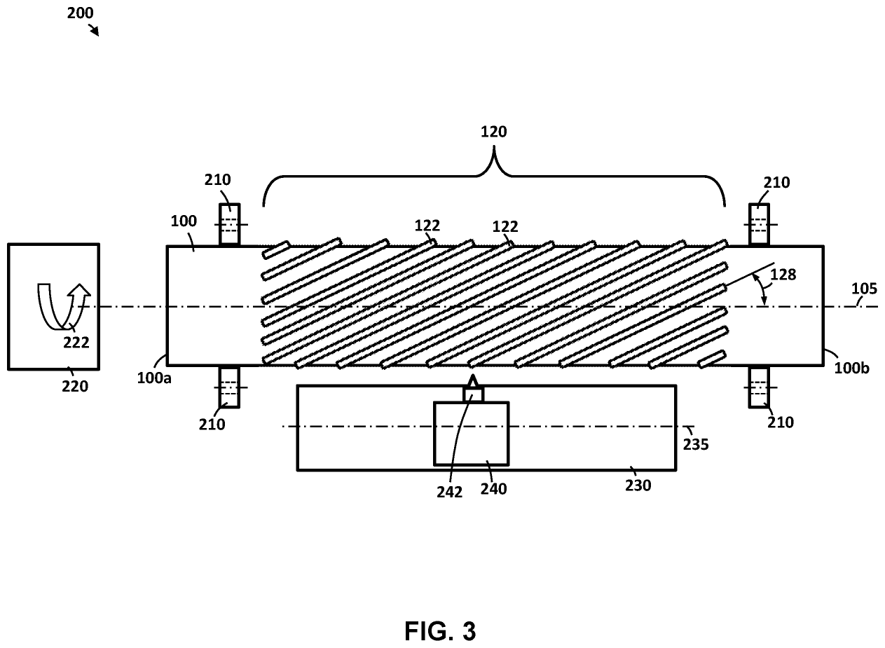

Referring now to FIG. 2, each tubular member 100 making up drill string 2 is an elongate tubular member that is configured to be threadably connected to each adjacent tubular member 100 or other component (e.g., drill bit 6, a bottom hole assembly (BHA), etc.). Specifically, each tubular member 100 includes a central or longitudinal axis 105, which may be aligned with axis 5 of drill string 2 during operations, a first or upper end 100a, a second or lower end 100b opposite upper end 100a, a radially outer surface 100c extending axially between ends 100a, 100b, and a radially inner surface 100d defining a throughbore 104 that also extends axially between ends 100a, 100b. In some embodiments, throughbore 104 is concentrically aligned with axis 105.

A threaded connector is disposed at each end 100a, 100b to facilitate the threaded connection of tubular members 100 within drill string 2 as previously described. In particular, a first threaded connector 106 is disposed at first end 100a and a second threaded connector 110 is disposed at second end 100b. In some embodiments, first threaded connector 106 comprises a female threaded connector, which may be referred to herein as a box connector 106, while the second threaded connector 110 comprises a male threaded connector, which may be referred to herein as a pin connector 110. Box connector 106 may comprise one or more internal threads, while the pin connector 110 may comprise one or more external threads. In some embodiments, first end 100a may be disposed uphole of second end 100b within drill string 2. Thus, along drill string 2 of FIG. 1, pin connector 110 of a first tubular member 100 may be threadably engaged with box connector 106 of an axially adjacent, second tubular member 100 that is positioned downhole from first tubular member 100. The thread profile along box connector 106 and pin connector 110 may be any suitable thread profile (e.g., API threads, proprietary threads, straight threads, etc.).

Referring still to FIG. 2, tubular member 100 may also include one or more upsets disposed between ends 100a, 100b. As used herein, the term “upset” generally refers to an increase in the cross-sectional area at a particular portion of a tubular member (e.g., tubular member 100) relative to the cross-sectional area of an axially adjacent portion of the tubular member. In particular, in some embodiments, the box connector 106 includes an upset 107, and the pin connector 110 includes an upset 111. A central region or section 108 of tubular member 100 extends axially between pin connector 110 and box connector 106 (and thus also axially between upsets 111 and 106). As may be appreciated from FIG. 2, the radially outer surface 100c is expanded radially outward along the upsets 107, 111 so that the outer diameter of the tubular member 100 is greater along upsets 107, 111 than along the central region 108. In some embodiments, one or both of upsets 107, 111 may not be included along tubular member 100.

Upset 107 and 111 at box connector 106 and pin connector 110, respectively, may be secured to tubular member 100 via any suitable method, (e.g., welding, integral formation, etc.). For example, in some embodiments, upsets 107, 111 along connectors 106, 110, respectively, are formed by heating ends 100a, 100b of tubular member 100, and impacting each heated end along axis 105, thereby forcing one or more diameters (e.g., surfaces 100c, 100d) to radially expand in the manner described above. In addition, in some embodiments upsets 107, 111 may be formed along each end of central region 108 in the manner previously described, and then threaded connectors 106, 110 (which may be formed separately) are be secured (e.g., welded) to the upsets 107, 111.

Referring still to FIG. 2, tubular member 100 also includes a weld overlay 120 positioned axially between ends 100a, 100b, within the central region 108. In some embodiments, the weld overlay 120 is substantially axially mid-way between ends 100a, 100b (or threaded connectors 106, 110) along central region 108. In some embodiments, the weld overlay 120 is axially closer to one of the ends 100a, 100b (or threaded connectors 106, 110). Generally speaking, weld overlay 120 is formed by a plurality of weld beads 122 which are arranged along central region 108.

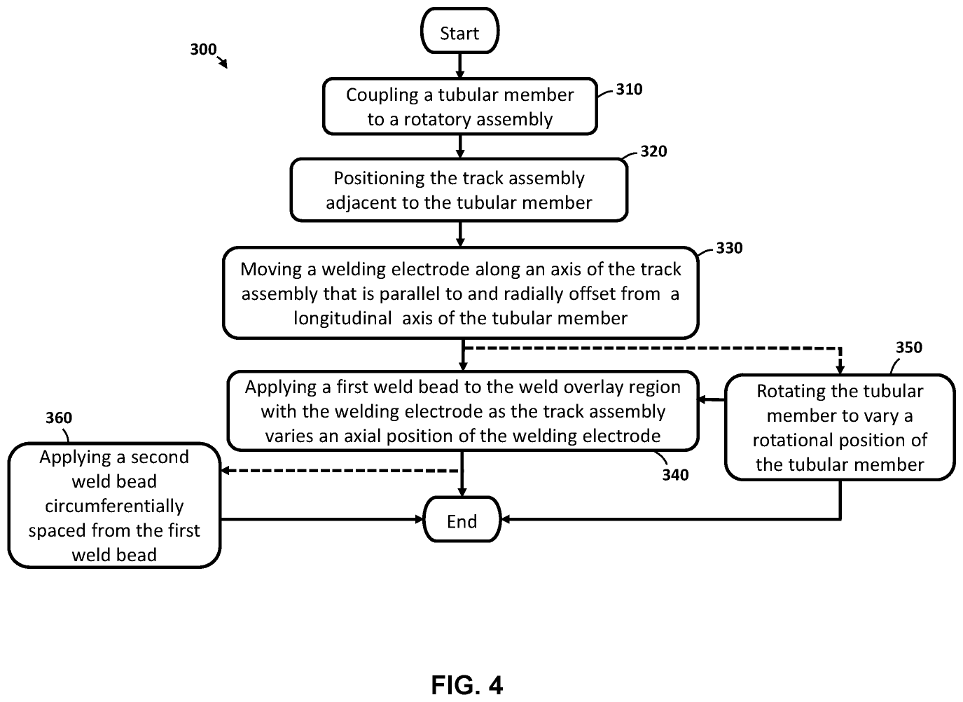

Weld beads 122 may be arranged along radially outer surface 100c in a number of patterns. For instance, in some embodiments (e.g., such as the embodiment of FIG. 2), the plurality of weld beads 122 are arranged in a helical pattern about axis 105. Specifically, weld beads 122 each extend helically about axis 105 such that weld beads 122 are parallel and non-overlapping relative to one another. In some embodiments, each weld bead 122 may circumscribe at least 360° about axis 105; however, weld beads 122 that extend less than 360° may be included in some embodiments. In addition, in some embodiments (e.g., such as in the embodiment of FIGS. 2 and 3), each of the weld beads 122 may be continuous lines or may comprise a plurality of spaced segments. Weld overlay 120 may comprise any suitable number of weld beads 122, such as, for instance, 1, 2, 3, 4, 5, 6, 7, 8, 9, 10, etc. weld beads 122. In some embodiments, weld overlay 120 may extend along about 3 feet or about 1 meter of the axial length of tubular member 100 with respect to axis 105. In some embodiments, the weld overlay 120 may extend along about 5% to about 15% of the total axial length of tubular member 100.

The weld beads 122 of weld overlay 120 may extend helically in a first direction about axis or in a second direction about axis 105 that is opposite the first direction (e.g., clockwise or counter clockwise as viewed along axis 105 from one of the ends 100a, 100b). Without being limited to this or any other theory, the choice of rotational direction of the helical weld beads 122 may be made based on the ultimate use or desired functionality of the tubular member 100. For instance, the chosen direction of the helical weld beads 122 may facilitate the upward flow of fluids within the borehole (borehole 12 in FIG. 1) for a given direction of rotation about axis 105 during drilling. In addition, the chosen direction of the helical weld beads 122 may also allow for suitable engagement with the walls of the borehole (e.g., borehole 12 in FIG. 1) during operations (e.g., drilling) that may prevent the tubular 100 from becoming stuck within the borehole.

Alternatively, in some embodiments, the weld beads 122 within welded overlay 120 (or at least some of the weld beads 122) may extend axially with respect to axis 105. Thus, in some embodiments, weld overlay 120 may comprise a plurality of parallel, axially extending weld beads 122 that are circumferentially spaced (e.g., evenly circumferentially spaced) from one another about axis 105. In some embodiments, weld beads 122 within welded overlay 120 (or at least some of the weld beads 122) may extend circumferentially with respect to axis 105. Thus, in some embodiments, weld overlay 120 may comprise a plurality of parallel, circumferentially spaced weld beads 122 that are axially spaced from one another along axis 105, so that the weld beads 122 form a plurality of axially spaced hoops or rings about radially outer surface 100c. In addition, in some embodiments, weld overlay 120 may comprise intersecting, overlapping, or partially overlapping portions of weld beads 122. For example, a crossing helical pattern may be applied by applying subsequent weld beads 122 while reversing the direction of tubular member 100 rotation about axis 105, as discussed further below.

Because the weld beads 122 are disposed along the radially outer surface 100c, weld beads 122 may provide a general increase in the outer diameter of tubular member along the weld overlay 120 as compared to the other portions or sections of central region 108. In some embodiments, the weld beads 122 may provide an increase of at least 0.5 inches to the outer diameter of tubular member 100 as compared to the other portions of central region 108.

Referring now to FIG. 3, system 200 is shown which may be used to form weld overlay 120 on tubular member 100 as shown in FIG. 2. In the depiction of FIG. 3, box connector 106, pin connector 110, (and thus also upsets 107, 111) are omitted so as to simplify the drawing and to emphasize the weld overlay 120.

Generally speaking, system 200 comprises a plurality of guides 210 which are configured to support tubular member 100 as weld beads 122 are formed on radially outer surface 100c. Guides 210 may be distributed along the length of tubular member 100 and may be configured to support the weight of tubular member 100 horizontally as shown. However, in some embodiments guides 210 may also support tubular member 100 in a vertical orientation. In some embodiments, a pair of guides 210 may be positioned in radially opposing positions relative to axis 105 and proximate to first end 100a and second end 100b of tubular member 100. In some embodiments, guides 210 may comprise rollers that may rotate about axes that are parallel to and radially offset from axis 105 (e.g., when guides 210 are engaged with tubular member 100 as shown in FIG. 3).

In addition, system 200 comprises a rotary assembly 220 which is coupled to an end (e.g., such as first end 100a shown in FIG. 2) of tubular member 100 and is configured to rotate tubular member 100 about axis 105 during operations. Further, system 200 comprises a track assembly 230 having an axis 235 which is radially offset and parallel to axis 105 (e.g., when tubular member 100 is supported within system 200). A welding head 240 having a welding electrode 242 is movably coupled to track assembly 230. In particular, in some embodiments, welding head 240 may be slidably coupled to track assembly 230 such that welding head 240 may translate along axis 235. As a result, track assembly 230 may maintain welding electrode 242 at a generally constant distance or radial offset from radially outer surface 100c of tubular member 100 as welding head 240 is translated axially along axis 235. In addition, in some embodiments, guides 210 may comprise spherical type supports and tubular member 100 may be both rotated and translated axially with respect to axis 105. In particular, track assembly 230 may be omitted such that welding head 240 and welding electrode 242 are held stationary, while rotary assembly 220 may be configured to provide both rotation and translation to tubular member 100, when coupled therewith.

Referring still to FIG. 3, before weld beads 122 are applied to tubular member 100, tubular member 100 (or a portion thereof) may be prepared (e.g., ground, abraded, bead blasted, etc.) to remove impurities (e.g., paint, coatings, oxidation, etc.) along the radially outer surface 100c. During operation, rotary assembly 220 may rotate tubular member 100 while welding head 240 translates along travel direction axis 235. Simultaneously, welding electrode 242 may heat and or melt portions of tubular member 100 as the material of welding electrode 242 is added to tubular member 100 to form weld beads 122.

The speed of rotation of tubular member 100 (e.g., via rotary assembly 220) and the translation speed of welding head 240 along axis 235 determine a pitch angle 128 between axis 105 and each weld bead 122. In some embodiments, the pitch angle 128 may be about 100 to about 40°. Without being limited to this or any other theory, a lower pitch angle may result in less weld material along a given axial length of tubular member 100 (e.g., along axis 105), which may reduce an amount of material of tubular that may be affected by the heat of the welding process.

In some embodiments pitch angle 128 may be selected such that only a single weld bead 122 is used within weld overlay 120, as weld bead 122 may make numerous revolutions around axis 105. Alternatively, a plurality of weld beads 122 may be used, which are circumferentially spaced around axis 105. In addition, in some embodiments, the tubular member 100 may be preheated (e.g., via a furnace, inductive heater, oxy-acetylene torch, etc.) prior to and or during the application of weld beads 122.

In some embodiments, welding head 240 may be a gas metal arc welding (GNAW) type welding head, such as for example, a metal inert gas (MUG) welding head. However, other suitable varieties of welding may be used in various embodiments (e.g., arc, electroslag, flux-cored, gas tungsten, plasma arc, shielded-metal arc, submerged arc, tungsten inert gas, etc.). In some embodiments, alternating current (e.g., AC welding) or direct current (e.g., DC welding) power sources may be used when applying weld beads 122. In some embodiments, AC welding may offer the advantage of lowering the heat input into tubular member 100. In particular, the discontinuous welding arc provided by AC welding may increase the welding electrode 242 melting rate and lower the melting rate of material along weld overlay 120 of tubular member 100, thus minimizing the damage to the base material mechanical properties (e.g., reducing the size of the heat effected zone surrounding weld beads 122). Weld beads 122 are preferably formed using a seamless cored wire and the weld deposit is preferably formed substantially free of any cracks or voids. The weld wire may be, by way of example, manufactured by Voestalpine Bohler Welding (e.g., UTP AP Robotic 601).

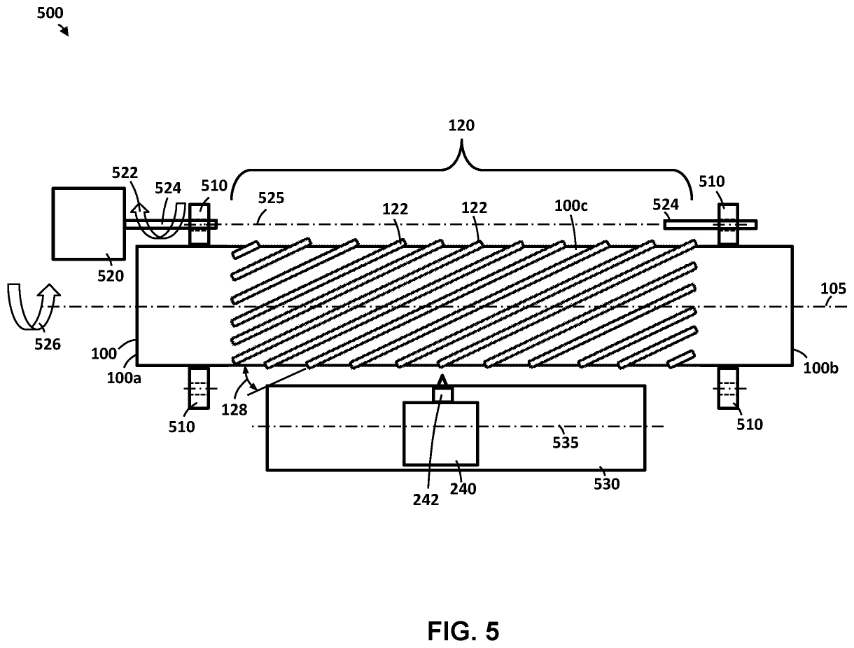

Referring to FIG. 4, a method 300 of using system 200 of FIG. 3 is shown. As a result, continuing reference is made to FIG. 3, while describing the features of method 300. Initially, method 300 includes coupling a tubular member to a rotary assembly in block 310. For instance, in the embodiment of FIG. 3, tubular member 100 is coupled to rotary assembly 220, such that rotation 222 may be imparted along axis 105 as tubular member 100 is supported along the plurality of guides 210.

Returning to FIG. 4, method 300 further comprises positioning a track assembly adjacent to the tubular member in block 320. For instance, in the embodiment of FIG. 3, track assembly 230 is positioned adjacent to tubular member 100.

Next, method 300 of FIG. 4 includes moving the welding electrode along an axis of the track assembly that is parallel to and radially offset from a longitudinal axis of the tubular member in block 330. For instance, in the embodiment of FIG. 3, welding head 240 and welding electrode 242 may be translated along an axis 235 of track assembly 230 that is parallel to and radially offset from axis 105 of tubular member 100. Accordingly, as welding head 240 and welding electrode 242 are translated along the axis 235 of track assembly 230, the welding electrode 242 is maintained at a substantially constant distance (e.g., a radially oriented distance with respect to axes 235, 105) from the radially outer surface 100c.

Referring still to FIG. 4, method 300 further comprises, at block 340, applying a first weld bead to the tubular member with the welding electrode during the moving of the welding electrode at block 330. For instance, in the embodiment of FIG. 3, as the welding head 240 and welding electrode 242 are translated along axis 235 relative to the tubular member 100, a first weld bead 122 may be applied with welding electrode 242 as previously described above.

Referring still to FIG. 4, method 300 may further comprise, at block 350, rotating the tubular member about a central axis of the tubular member during both the moving of the welding electrode at block 330 and applying the first weld bead at block 340. In particular, for the embodiment of FIG. 3, the concurrent rotation of the tubular member 100 about axis 105 (e.g., via rotary assembly 220) with the axial translation of welding head 240 along axis 235 and energization of welding electrode 242 may form the helical weld beads 122 as previously described above.

To manage the heat input rate into tubular member 100 during the welding process, the applying of weld bead 122 in process block 360 may be periodically halted as both the electrode moving of process block 350 and the rotating of process block 370 are also halted. In some embodiments, the applying of weld bead 122 in block 360 may be periodically halted as process blocks 350, 370 are continued, so as to form a segmented weld bead 122 along a helical path as previously described above. Without being limited to this or any other theory, application of segmented helical weld beads 122 may promote even distribution of residual stresses around the circumference of tubular member 100.

In some embodiments, applying the weld bead at block 360 may comprise making multiple passes of the welding electrode along the tubular member so as to form different portions or segments of a single weld bead. Without being limited by theory, by managing the heat input rate into tubular member 100, smaller heat effected zones may occur surrounding weld beads 122, less distortion of tubular member 100 may occur (e.g., bending or non-linearity along axis 105 or out of round distortions of central region 108), and more balanced residual stresses may occur between circumferentially adjacent portions of weld overlay 120.

Returning to FIG. 4, method 300 may further comprise applying a second weld bead in process block 360, the second weld bead being circumferentially spaced apart from the first weld bead along an axis of the tubular member. For instance, in the embodiment of FIG. 3, second weld bead 122 is applied in the same manner previously described for first weld bead 122. Subsequent weld beads 122 may be added to weld overlay 120 as needed to produce a series of non-overlapping helical patterns which are circumferentially spaced apart relative to axis 105 and which are substantially parallel in at least one axial position between first end 100a and second end 100b of tubular member 100.

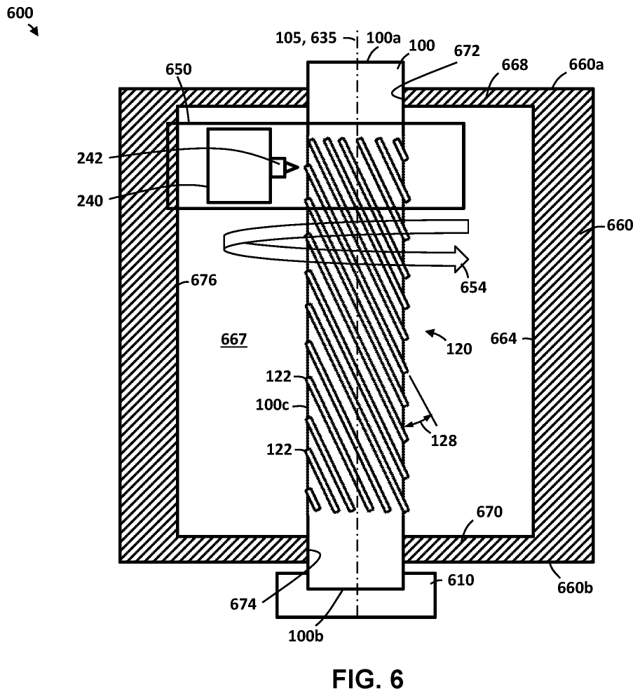

Referring to FIG. 5, another system 500 is illustrated which may be used to produce tubular member 100. Generally speaking, system 500 is similar to system 200 previously described, and thus, components of system 500 that are shared with system 200 are identified with like reference numerals, and the description below will focus on features of system 500 that are different from system 200. In particular, system 500 includes a rotary assembly 520 which may be positioned along an offset axis 525, which is offset from axis 105 of tubular member 100. Generally speaking, rotary assembly 520 may be configured to apply a rotation 522 along offset axis 525, which is then transferred to a rotation 526 along axis 105. In the manner previously described for rollers 210 of system 200, supports or rollers 510 may be configured to support tubular member 100 along axis 105. In particular, rollers 510 may be positioned in radially opposing positions relative to axis 105 and proximate to first end 100a and second end 100b of tubular member 100. Rollers 510 may be configured to rotate along offset axis 525 and may be coupled with rotary assembly 520 via one or more axles 524. Some of the plurality of rollers 510 may be configured to freely rotate with tubular member 100 and thus may be described as idler type rollers 510.

Referring still to FIG. 5, system 500 may further comprise a track assembly 530 having an axis 535 which is offset and parallel to axis 105 and a welding head 240 having a welding electrode 242. In some embodiments, welding head 240 may be movably coupled to track assembly 530, such that welding head 240 may translate along axis 535. As a result, track assembly 530 may maintain welding electrode 242 at a generally constant distance or radial offset from radially outer surface 100c of tubular member 100 as welding head 240 is translated axially along axis 535.

During operation of system 500, rotary assembly 520 may vary rotation 522, driving one or more rollers 510, which then drives rotation 526 of tubular member 100, while welding head 240 may independently translate along axis 535. The speed of rotation of tubular member 100 (e.g., via rotary assembly 520) and the translation speed of welding head 240 along axis 535 determine a pitch angle 128 between axis 105 and each weld bead 122, as each is applied in the manner previously described for system 200.

Referring to FIG. 6, another system 600 is illustrated which may be used to form weld overlay 120 on tubular member 100. Generally speaking, system 600 is similar to system 200 previously described, and thus, components of system 600 that are shared with system 200 are identified with like reference numerals, and the description below will focus on features of system 600 that are different from system 200. In particular, system 600 allows tubular member 100 to remain stationary, while welding head 240 and welding electrode 242 both rotate and translate with respect to axis 105 of tubular member 100. In the embodiment shown, tubular member 100 is held vertically stationary by support or base assembly 610 which is coupled to second end 100b of tubular member 100, however other portions of tubular member 100 may be coupled to, for example along first end 100a or both ends 100a, 100b. Tubular member 100 may also be supported in non-vertical orientations. System 600 comprises an axis 635 which is coincident with axis 105 of tubular member 100, a first end 660a, a second end 660b axially opposite first end 660a with respect to axis 635, and a track assembly 660 extending between ends 660a, 660b. In addition, inner wall 664 extends within track assembly 660 along axis 635 and forms a cavity 667 radially between inner wall 664 and axis 635. A first arm 668 extends from inner wall 664 at a position proximate to first end 660a and a second arm 670 extends from inner wall 664 at a position proximate to second end 660b. A first passage 672 and a second passage 674 may be provided at first end 660a and second end 660b, respectively, which provide a pass through for tubular member 100 along axis 635, when coupled therewith. Track assembly 660, inner wall 664, and arms 668, 670 may be any shape, and in some embodiments may be cylindrical, thus passages 672, 674 may also be cylindrical, each concentrically oriented with axis 635. In addition inner wall 664 may further comprise a track 676, which faces radially inward toward axis 635 and cavity 667. System 600 may further comprise a carriage 650 which is positioned within cavity 667 of track assembly 660 and which couples to track 676, to allow for translating motion along axis 635, which is generally aligned parallel with axis 105. In addition, the couple between carriage 650 and track 676 may be configured to allow a rotation 654 of carriage 650 relative to axes 105, 635. Welding head 240 and welding electrode 242 may be coupled to carriage 650, thus an approximately constant distance or offset may be established between electrode 242 and radially outer surface 100c of tubular member 100, as welding electrode 242 translates and or rotates with respect to axes 105, 635.

During operation of system 600, the speed of rotation 654 and the translation speed of carriage 650 may be controlled independently to determine a pitch angle 128 for weld beads 122 as each is applied in the manner previously described for system 200.

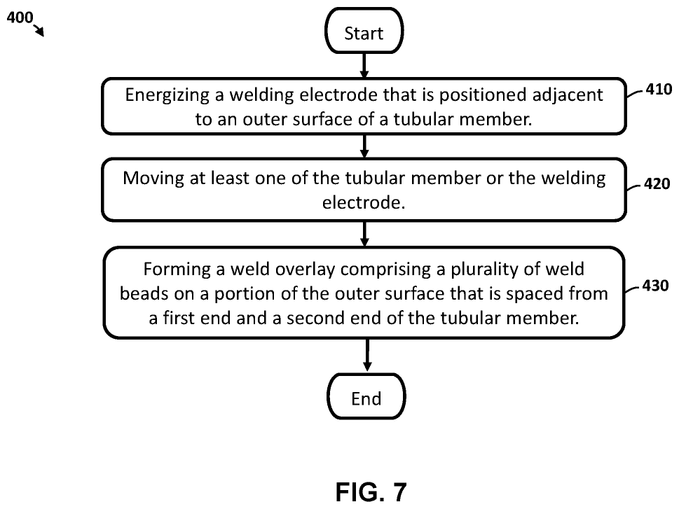

Referring now to FIG. 7, a method 400 of manufacturing a tubular member is shown. In some embodiments, the tubular member manufactured via the method 400 may comprise the tubular member 100 previously described above (see e.g., FIG. 2). In addition, in some embodiments, the method 400 may be performed using one of the systems 200, 500, 600, previously described above. Accordingly, in describing the features of method 400, reference may be made to the tubular member 100 of FIG. 2 and the systems 200, 500, 600 of FIGS. 3, 5, and 6; however, it should be appreciated that other systems may be used to perform method 400, and method 400 may produce a tubular member that may be different in some respects to tubular member 100.

Initially, method 400 includes energizing a welding electrode that is positioned adjacent to an outer surface of a tubular member at block 410. For instance, the welding electrode may comprise any of the welding electrodes 242 previously described above, and in some embodiments, the welding electrode may be mounted to a track assembly (e.g., track assemblies 230, 530, 660 of FIGS. 3, 5, 6, etc.) or other suitable structure that may position the welding electrode 242 at a desired distance (e.g., a radial distance with respect to a central axis of the tubular member) from the outer surface (e.g., outer surface 100c of tubular member 100 in FIG. 3).

In addition, method 400 includes moving at least one of the tubular member or the welding electrode at block 420. In some embodiments, block 420 may comprise moving both the welding electrode and the tubular member (e.g., such as rotating the tubular member 100 about axis 105, and translating welding electrode 242 via track assemblies 230, 530 as previously described above for the systems 200 and 500 of FIGS. 3 and 5, respectively). In addition, in some embodiments, block 420 may comprise moving only one of the tubular member or the electrode (e.g., such as fixing the position of the tubular member 100, while moving the welding electrode 242 relative to the tubular member 100 via track assembly 660 and carriage 650 as previously described above for system 600 in FIG. 6).

Further, method 400 also includes forming a weld overlay comprising a plurality of weld beads on a portion of the outer surface that is spaced from a first end and a second end of the tubular member at block 430. For instance, the weld overlay formed at block 430 may comprise a plurality of weld beads 122 for tubular member 100, previously described above. Thus, the description herein for the weld overlay 120 and weld beads 122 may be applied to describe the weld beads that may be formed on the tubular member as a result of block 430 in method 400.

Referring again to FIGS. 1 and 2, during a drilling operations, one or more of the tubular members 100 may be coupled together to form drill string 2 so that axes 105 of tubular member(s) 100 are aligned with axis 5. Thereafter, as drill string 2 (or a portion thereof) is rotated about axis 5, tubular member(s) 100 within drill string 2 may engage (e.g., impact, shear, etc.) the wall of borehole 12. Due to the placement (e.g., along axis 105 between ends 100a, 100b) and the relatively larger outer diameter of weld overlay 120, the engagement between the tubular members 100 and the wall of borehole 12 may take place along weld overlay 120 (and possibly also upsets 107, 111). However, the increased wall thicknesses along weld overlay 120 and upsets 107, 111 may allow these regions/surfaces to withstand a greater amount of wear during drilling operations. As a result, weld overlay 120 may provide tubular member 100 with a greater service life and durability than a standard tubular member. In addition, weld beads 122 may be produced with increased harnesses as compared to the other portions of central region 108, and thus weld overlay 120 may further resist wear and damage during drilling operations.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A tubular member, comprising:
a central axis, a first end, a second end opposite the first end, and an outer surface extending from the first end to the second end; and
a weld overlay disposed on a portion of the outer surface that is axially spaced from the first end and the second end, wherein the weld overlay comprises a plurality of weld beads.

2. The tubular member of claim 1, wherein the weld overlay is positioned substantially axially mid-way between the first end and the second end.

3. The tubular member of claim 1, wherein the plurality of weld beads are arranged in a helical pattern around the central axis.

4. The tubular member of claim 3, wherein the helical pattern extends a length along the central axis that is from about 5% to about 15% of a total axial length of the tubular member.

5. The tubular member of claim 3, wherein each of the plurality of weld beads circumscribes at least 360-degrees about the central axis.

6. The tubular member of claim 3, wherein the plurality of weld beads extend to an outer diameter that is at least 0.5 inches greater than an outer diameter of the portion of the outer surface.

7. The tubular member of claim 3, wherein each of the plurality of weld beads comprises a pitch angle that is from about 10° to about 40°.

8. The tubular member of claim 1, wherein the plurality of weld beads do not intersect one another.

9. The tubular member of claim 1, wherein the plurality of weld beads extend axially relative to the central axis on the portion of the outer surface.

10. The tubular member of claim 1, wherein the plurality of weld beads extend circumferentially relative to the central axis on the portion of the outer surface.

11. A method of manufacturing a tubular member, wherein the tubular member comprises a central axis, a first end, a second end opposite the first end, and an outer surface extending from the first end to the second end, the method comprising:
(a) energizing a welding electrode that is positioned adjacent to the outer surface;
(b) moving at least one of the tubular member or the welding electrode during (a); and
(c) forming a weld overlay comprising a plurality of weld beads on a portion of the outer surface that is axially spaced from the first end and the second end with the welding electrode during (a) and (b).

12. The method of claim 11, wherein (c) further comprises forming the plurality of weld beads in a helical pattern on the portion of the outer surface.

13. The method of claim 11, wherein the plurality of weld beads comprises a pitch angle that is from about 10° to about 40°.

14. The method of claim 12, wherein (c) further comprises forming each of the plurality of weld beads to circumscribe at least 360-degrees about the central axis.

15. The method of claim 11, wherein (b) further comprises:
(b1) rotating the tubular member about the central axis; and
(b2) translating the weld electrode in a direction that is a parallel to the central axis.

16. The method of claim 11, wherein (b) further comprises:
(b1) fixing a position of the tubular member; and
(b2) moving the weld electrode over the portion of the outer surface.

17. The method of claim 11, wherein (c) further comprises increasing a maximum outer diameter of the portion of the outer surface by at least 0.5 inches with the plurality of weld beads.

18. The method of claim 11, wherein (c) further comprises forming the weld overlay substantially axially mid-way between the first end and the second end.

19. The method of claim 11, wherein the plurality of weld beads extend axially relative to the central axis on the portion of the outer surface.

20. The method of claim 11, wherein the plurality of weld beads extend circumferentially relative to the central axis on the portion of the outer surface.
